(19) United States
(12) Patent Application Publication
(10) Pub. No.: US 2007/0233603 A1
(43) Pub. Date: Oct. 4, 2007

(54) Flexible routing of electronic-based transactions

(76) Inventors: Matthew M. Schmidgall, Elgin, IL (US); Nicholas J. Starai, Wayne, IL (US)

Correspondence Address: PATTI, HEWITT & AREZINA LLC, ONE NORTH LASALLE STREET, 44TH FLOOR, CHICAGO, IL, 60602, US

(21) Appl. No.: 11/583,301

(22) Filed: Oct. 18, 2006

Related U.S. Application Data
(60) Provisional application No. 60/787,243, filed on Mar. 30, 2006.

(51) Int. Cl. G06Q 99/00

(52) U.S. Cl. 705/51

(57) ABSTRACT

A transaction routing apparatus includes a database that stores predetermined rules defined by a merchant where the database also stores the identity of at least one transaction processor associated with each predetermined rule. A rule matching module compares the predetermined rules with supplemental information related to the transaction to determine if any of the rules are satisfied. A selection module transmits the transaction information (information for a requested purchase by a customer of goods or services of the merchant) to the selected transaction processor associated with the rule that is satisfied.

### BACKGROUND

This invention relates to the electronic processing of transactions completed by transmitting and receiving transaction information between customers and merchant account processors. This includes, but is not limited to, credit card transactions. The invention is more specifically directed to how such transactions are routed from an originating customer to a particular merchant account processor.

Credit and/or debit card transactions provide an ever-increasing percentage of transactions especially for retail customers. A credit cardholder typically presents his credit card to a point-of-sale merchant for payment of merchandise being purchased. Alternatively, the cardholder can read his credit card information to a merchant during a telephone purchase of an item, input his credit card information via a merchant's web site during a purchase of an item over the internet, or transmit his e(electronic)-check information to the merchant. The merchant transmits the credit card number (and any other required information, e.g. expiration date) along with information concerning the merchandise being purchased to a payment gateway. The payment gateway converts the credit card transaction information into a format and signaling protocol required by a credit card processor associated with the institution or association that issued the cardholder's credit card. The payment gateway transmits the converted information to the credit card processor for validation and acceptance of the transaction. Assuming the transaction is accepted, confirmation of the acceptance is transmitted from the processor back through the payment gateway to the originating merchant, thereby completing the transaction.

Although this processing serves its intended purpose, merchants would welcome increased flexibility with regard to their ability to control the routing of transactions to selected processors. For example, a merchant may have a contractual agreement with a first processor that limits the number or value of transactions be processed during the time interval such as a month. Or the merchant may be offered incentives to utilize a particular processor for certain types of transactions. Such situations typically require that the merchant have a separate, different account with each of the processors so that a particular merchant account can be utilized to process various transactions according to the desire of the merchant. Therefore, a need exists to provide the merchant with increased flexibility with regard to the routing of transactions from a merchant to various transaction processors.

### SUMMARY

It is an object of the present invention to satisfy this need.

In one embodiment of the present invention, a transaction routing apparatus includes a database that stores predetermined rules defined by a merchant where the database also stores the identity of at least one transaction processor associated with each predetermined rule. A rule matching module compares the predetermined rules with supplemental information related to the transaction to determine if any of the rules are satisfied. A selection module transmits the transaction information (information for a requested purchase by a customer of goods or services of the merchant) to the selected transaction processor associated with the rule that is satisfied.

Another embodiment of the present invention includes a method for selecting a transaction processor to handle each of the transactions tendered by a merchant.

A further embodiment of the present invention includes an article including one or more computer-readable signal-bearing media for causing the method for selecting a transaction processor to be implemented.

### DESCRIPTION OF THE DRAWINGS

Features of exemplary implementations of the invention will become apparent from the description, the claims, and the accompanying drawings in which:

FIG. 1 illustrates the various entities associated with the processing of an electronic transaction.

FIG. 2 is a block diagram of an illustrative payment gateway as shown in FIG. 1.

FIGS. 3A and 3B comprise a flow diagram of steps of an illustrative method in accordance with an embodiment of the present invention by which a decision is made of the processor that is to handle a transaction.

FIG. 4 is a flow diagram of steps of an illustrative method by which a merchant defines a set of rules that control the selection of a processor to handle the transaction.

### DETAILED DESCRIPTION

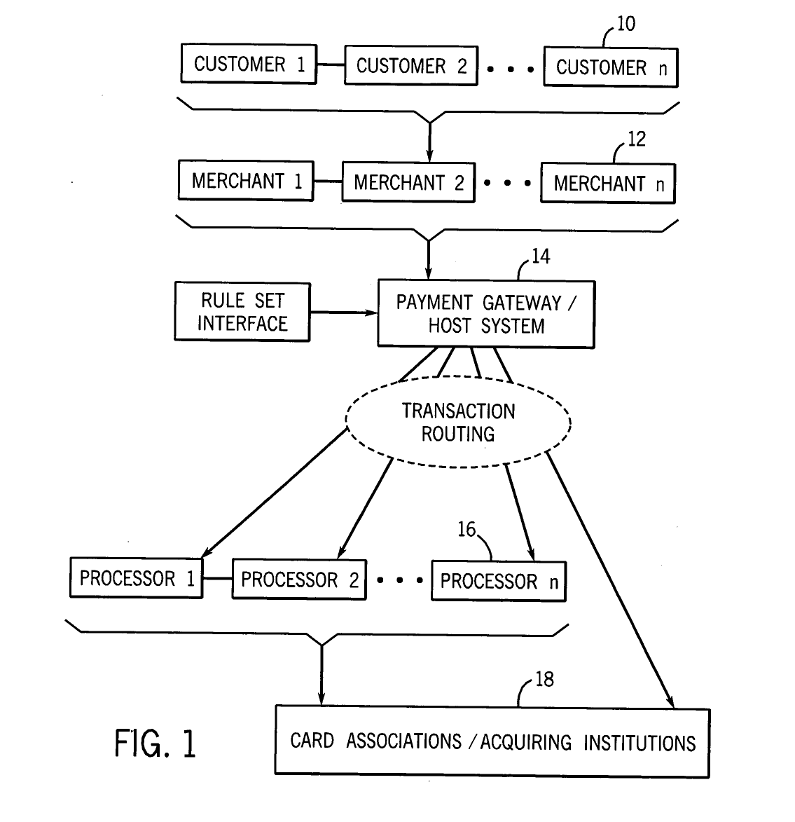

FIG. 1 provides an overview of the entities associated with an electronically processed transaction. A credit card transaction will be described herein as an example of such an electronically processed transaction. Customers, e.g. credit cardholders, 10 will typically select desired merchandise or services available from one of the merchants 12. Credit card information is provided to the merchant. It will be understood that the merchant will have previously established a contractual relationship with one or more processors 16 and one or more payment gateways 14 in order to process credit card transactions for customers. The merchant 12 transmits the transaction information including the credit card number, merchandise information and amount to be purchased to the payment gateway 14. This transaction information is typically received by the payment gateway in a format and/or signal protocol that would not be understood by an end processor 16. One of the functions of the payment gateway is to convert the transaction information to an appropriate format and signal protocol accepted by the destination processor 16.

In accordance with an embodiment of the present invention, the payment gateway 14 which is a host computing system provides additional selection criteria and conditions that can be utilized by the merchant in order to control which of the processors 16 will receive the transaction information. The merchant or agent acting for the merchant predefines a set of rules stored in or accessible by the host system that controls which of the processors 16 will receive the transaction for processing. It will be noted that this set of rules is controlled by the merchant (or an agent for the merchant), not by the cardholder/purchaser. The processors 16 may be considered to be front end processing facilities associated with one or more of the card association/financial institutions 18 with which the merchant has an account. Bidirectional communications are provided between the originating merchant 12 and the destination association/institution 18. After validation of the account associated with the credit card number and acceptance of a debit to customer's account in the amount of the tendered transaction, the association/institution 18 will transmit an acceptance or completion signal back to the originating merchant thereby completing the transaction. Alternatively, lack of validation or declining to accept the debit to the customer's account will result in the transmission back to the originating merchant of an error or decline indication. If a destination association/institution 18 has incorporated the functionality of the processors 16, then the transaction routing can flow directly from the gateway 14 to the destination association/institution 18.

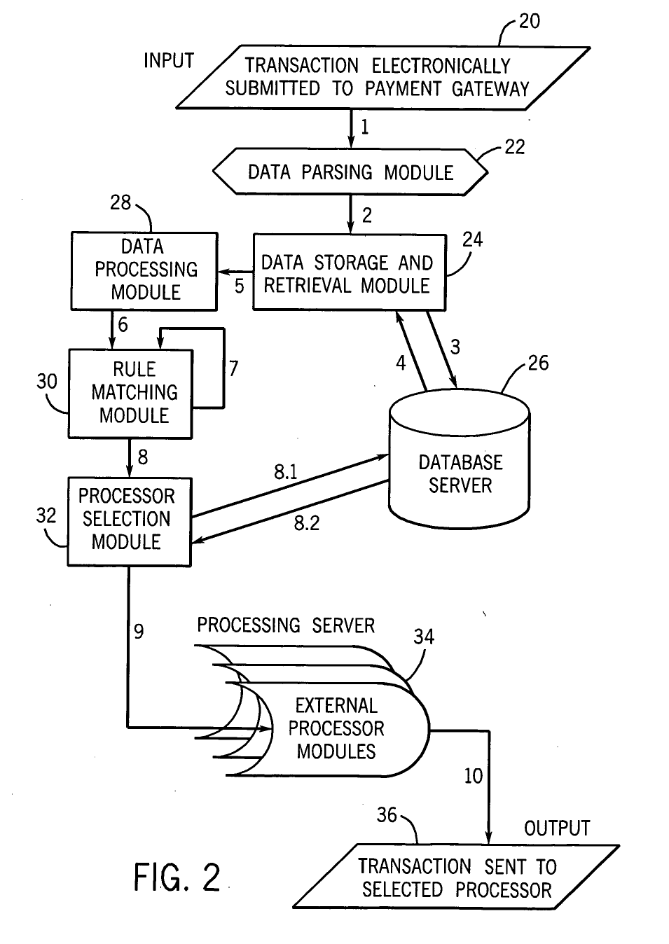

FIG. 2 is an illustrative block diagram of an exemplary payment gateway 14. A receiver 20 receives the transaction information electronically transmitted to the payment gateway from the originating merchant. The transaction information is transmitted to a data parsing module 22 that parses the received information into different fields containing corresponding transaction information. This parsed information is then transmitted to a data storage and retrieval module 24 that transmits the information for storage to database server 26. Additional information associated with the transaction is retrieved and/or derived by the database server 26 for processing in conjunction with the received transaction information. For example, such additional information could comprise the geographic location of the originating merchant, the cardholder's geographical location, geographic location from which or to which merchandise will be shipped, location of an Internet customer, IP address of the customer, a range of amounts allowed for processing, specific merchandise information, type of transaction, payment type, predefined merchant processing information associated with the originating merchant, date restrictions, third-party service requirements, transaction history associated with customer's account, re-routing instructions in the event of an error or declination by the credit card company, and/or particular routing instructions based on the originating merchant, amount of purchase, cumulative transaction accounts within a set time interval with a specific processor and/or credit card company. This additional information is returned to module 24 and is routed together with the original transaction information to the data processing module 28. Module 28 formats the transaction information and other additional information, and transmits it to the rule matching module 30.

The rule matching module 30 applies a predetermined set of rules to the transaction information and additional information in order to determine which of the processors 16 are to receive this transaction request. The rules correspond to the various selection criteria as explained above. The selection criteria is controllable by the originating merchant in order to provide increased flexibility with regard to the routing of processing of transactions associated with each merchant. For example, a merchant could establish a defined criteria which would allow the merchant to utilize a single account with the host system/payment gateway 14 and yet utilize different processors for different transactions based on the criteria as defined and controlled by the merchant. Following the determination by the rule matching module 30 of which conditions meet which rules, the transaction along with the rule selection information is transmitted to the processor selection module 32 which determines the particular processor to receive the transaction request based on a comparison of the additional information and the rules. The processor selection module is also preferably in communication with the database server 26 so that any information needed by or helpful to module 32 in making the selection can be accessed from the database, and so that the selection can be stored in the database for later use. A plurality of external processor modules 34 are coupled to corresponding processors and route the transaction request to a corresponding processor 16 as indicated by output 36. The numbers associated with the paths as shown in FIG. 2 provide an illustrative numerical sequence of operation and/or data flow. FIGS. 1 and 2 focus on the transmission of information from the merchant to the processor and financial institution for clarity of explanation. However, those skilled in the art will understand that bidirectional communication is provided so that the merchant can receive information, e.g. confirmation of acceptance or denial of the transaction, from the selected financial institution.

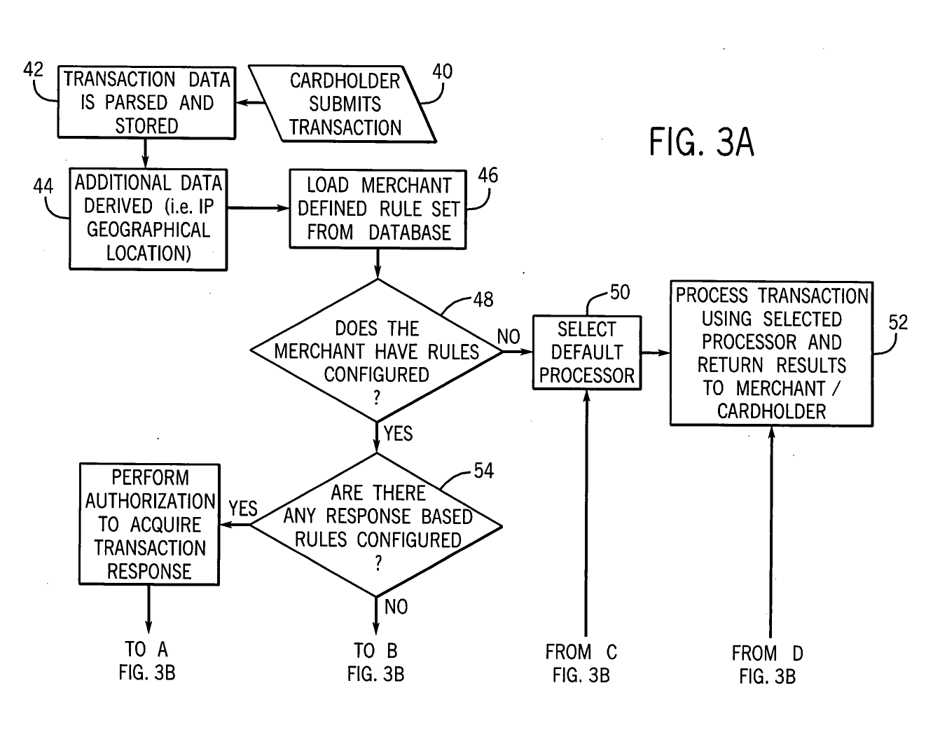

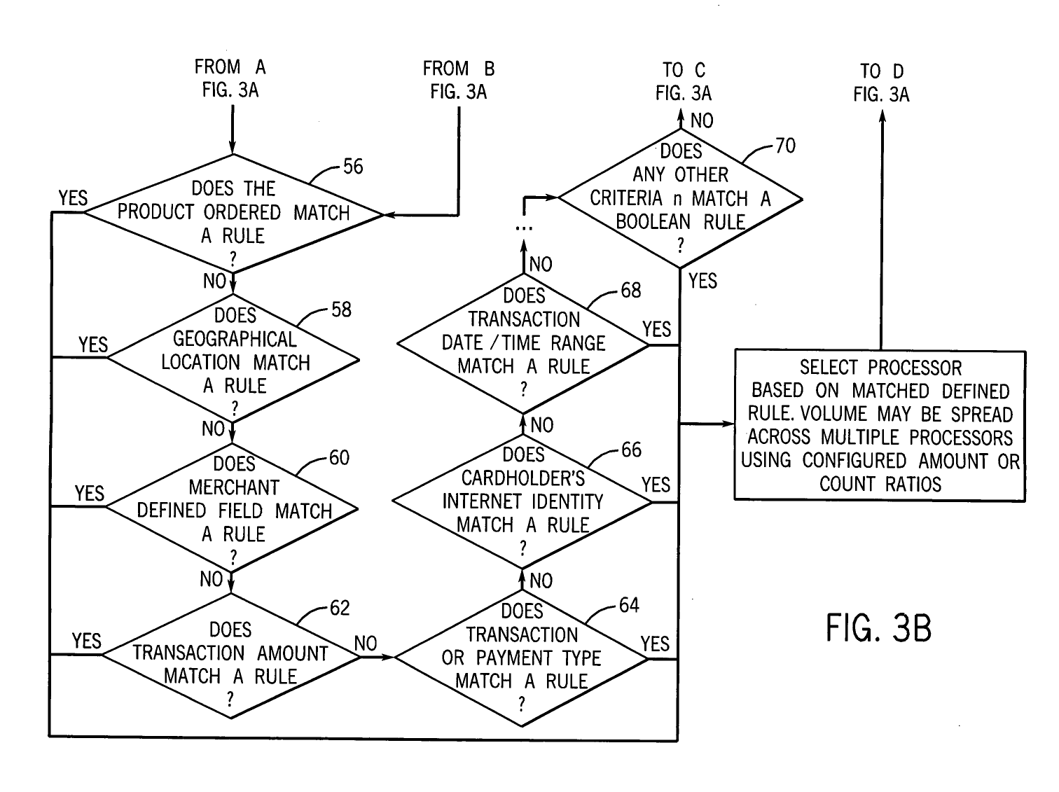

FIGS. 3A and 3B show a diagram of steps in accordance with an illustrative method. Upon receipt of the cardholder transaction information at step 40, the transaction data is parsed and stored per step 42. Additional data relevant to the processing decision is obtained at step 44 and merchant defined rules are located and retrieved from the database in step 46. A determination by step 48 is made of whether the merchant has rules configured and stored in the database. A NO determination results in a default processor being selected at step 50 and the transaction routed accordingly per step 52. A YES determination results in a series of further determinations in steps 54-70 that compare the transaction request and related additional information to a variety of predetermined rules that will determine which processor is to receive the transaction request. As indicated, a YES determination of one of the rule determination decisions results in a particular processor being determined to receive the transaction request. Alternatively, the rules may be considered in parallel, instead of in series, in order to permit a positive determination of more than one rule to be utilized in determining which processor to receive the transaction request. Other data/information beyond that found in the initial transaction request can be accessed where dynamic routing, as explained below, is utilized.

Providing such flexibility of processor selection to the originating merchant will enable the merchant to achieve processing control and goals not previously achievable, or only achievable with substantial additional cost and complexity. Additional information related to embodiments of the present invention is provided below.

In accordance with embodiments of the present invention, an Advanced Transaction Routing Interface (ATRI) system is a rule based payment transaction routing system. Traditionally, merchants submit payment transactions (i.e. credit card transactions) through a Payment Gateway, which formats the transaction and sends them to a payment processor. The ATRI system will allow merchants to configure a complex rule based routing system to determine which processor a transaction should be sent to. The processor can be determined by ATRI when:
1. The transaction first enters the Payment Gateway (Source Based Routing)
Or
2. The transaction can be re-routed after the response from the first payment processor is returned. (Response Based Routing)
   Once the routing scheme has been matched, one of the defined processors will be selected based on the Processor Selection Criteria. Rules can be tiered or multiple level. The rule set will be comprised of one base rule and many sub-rules. Each sub-rule can contain its own set of sub-rules. An example is provided below.
Currently utilized gateways and payment processors send specific transactions to payment processors based on card type.
1. The illustrative embodiment routes based on numerous criteria.
2. The illustrative embodiment can route based on many combinations of criteria. For example, a transaction might have to match a county and email host to be routed to a specific processor.
3. The illustrative embodiment can route to multiple processors if a rule is matched. The processor will be selected based on how much prior volume or the number of transactions that have been sent through the processor during a specific time period. (i.e. the current month)
4. The illustrative embodiment allows for multi-tiered rule sets. This allows one to combine routing behaviors (i.e. volume based process selection can cascade to sub-rules)
5. The illustrative embodiment can re-route transactions. This means that if a merchant wants to re-route transactions where the address verification returned “ADDRESS MISMATCH”, the system can cancel and re-submit the transaction through another processor.

### Example of Defined Rule Set

### For all transactions, route up to $1,000,000 through Processor A and $1,000,000 through Processor B. If processing exceeds limits, default to Processor A.

For all transactions originating from the US, route up to $500,000 through Processor A and $1,000,000 through Processor B. If processing exceeds limits, default to Processor A.
   For all transactions between $0.00 and $5.00, only use Processor A.
   For all transactions between $5.01 and $10.00, route up to $100,000 through Processor A and $100,000 through Processor B. If processing exceeds limits, default to Processor A.

### Source Based Routing

Cardholder's Geographical Location
Country of the Cardholder
City of the Cardholder
Province of the Cardholder
State of the Cardholder
Postal Code of the Cardholder (by Postal Code or Radius)
Email address of the Cardholder
Full Name of the Cardholder

Shipping Location's Geographical Location
Country of the Shipping Location
City of the Shipping Location
Province of the Shipping Location
State of the Shipping Location
Postal Code of the Shipping Location (by Postal Code or Radius)
Email address of the Shipping Location
Full Name of the Shipping Location

Internet User
Country of the Internet User
City of the Internet User
Province of the Internet User
State of the Internet User
Postal Code of the Internet User (by Postal Code or Radius)

IP Address
Internet User's Host Name
Internet User's ISP
Internet User's Subnet (A/B/C)
Internet User's IP Address

Amount
A range of the total transaction amount

Product/Order Id
Product Item ID/SKU
Order ID
Purchase Order Number
Order Description
When configuring routing rules, one has the ability to configure using wildcards.

Transaction Type
Authorization-Only
Sales
Refunds
Credits

Payment Type
The type of Payment (Credit/Debit/Check)
The Association of the Credit/Debit Card
The BIN of the Credit/Debit Card
The Routing Number of the Checking Account

Merchant Defined Field
Custom merchant defined variables. This may include:
   Originating Sales Agent
   Payment number in a recurring plan
When configuring routing rules, one has the ability to configure using wildcards.

Time/Day/Month
Time range the transaction is performed
Day of week the transaction is performed
Day of month the transaction is performed
Week of month the transaction is performed
Month of year the transaction is performed

Source
The source interface of the transaction
   Virtual Terminal
   Recurring
   Batch Web Upload
   Batch FTP Upload
   API
   Shopping Cart
The originating web site of the transaction
The originating call center of the transaction
The originating retail geographical location of the transaction
   Country of the Retail Location
   City of the Retail Location
   Province of the Retail Location
   State of the Retail Location
   Postal Code of the Retail Location (by Postal Code or Radius)
Retail Products
   Check Reading Hardware
   RF (Radio Frequency) Payment Device
   POS Credit Card Terminal

User Account
The individual gateway user who performed the transaction

Third-Party Service
Risk/Fraud Scoring System
Fraud Scrubbing System
User Verification System

Transaction History
Number of pervious successful or attempted transactions by the same credit card/IP address/email/full name
Existence of specific previous transaction statuses by the same credit card/IP address/email/full name
   Chargebacks
   Refunds
   Credits
   Sales
   Returned Checks

### Response Based Routing

AVS (Address Verification Service) Status
If the AVS status was returned as something specific, route it to another processor.
   Address information not provided
   AVS Error
   Non US Card Issuing Bank
   Retry, System Unavailable
   AVS is not supported by card issuing bank
   Address information for cardholder is unavailable
   Street address matches and first 5 digits of Zip Match
   Street address matches and first 5 digits of Zip do not Match
   Street address does not match and 9 digits of Zip Code Match
   Street address does not match and 5 digits of Zip Code Match
   Street address does not match and 5 digits of Zip do not Match

CVV2 Status
If the CVV status was returned as something specific, route it to another processor.
   Not processed
   Does not match
   Should be on card, but not indicated
   Issuer is not certified or has not provided encryption key

### Processor Selection Criteria

Route to Specific Processor
Transactions matching a rule will be submitted through one specific processor.

Route to Multiple Processors
Transactions matching a rule will be submitted through one of the multiple processors allowed according to inherited volume or count selection criteria.

Route Across Multiple Processors Based on Transaction Volume
Transactions matching a rule will be submitted through one of many processors depending on how much volume has been transaction through each processor.

Route Across Multiple Processor Based on Transaction Count
Transactions matching a rule will be submitted through one of many processors depending on the number of transaction that have been sent through each processor.

### As used herein, “international” refers to a country other than the United States, e.g. an international merchant is a merchant based in a country other than the United States.

### Source Based Routing

Source Based Routing is routing that can be determined based only on the transaction information received by the host system from the merchant. No other action or auxiliary information is necessary to determine whether this transaction matches a predetermined rule. For example, a merchant may have been issued three MIDs (Merchant Identification Number), one approved for large ticket domestic sales, another for small ticket domestic sales and a third for international sales. The merchant can configure the routing system to automatically:
Send transactions that have originated from the US and exceed or equal $200 to the first MID;
Send transactions that have originated from the US and are less than $200 to the second MID;
Send transactions that have originated outside the US to the third MID.

### This automatic routing will dramatically decrease the complexity of managing the three MIDs while staying in compliance with their merchant service provider.

### Boolean Sets of Rules

Rules can be simply single criterion rules, however, the interface provided to the merchant allows for more complex, multi-criterion rules. Boolean rule sets are rules that are defined by criteria requirements combined by AND or OR Boolean operations. For example, a rule could consist of the following:
country is US AND (amount>200 OR state is IL)

### If this rule is true, route to a first processor; if it is false, route to a second processor.

### Dynamic Routing

Dynamic routing is routing that cannot be determined based only on the transaction data received from the merchant. For example, a merchant may choose to have fifty percent volume flow through processor A and fifty percent through processor B per month. In this situation, when a transaction is first initiated by the cardholder and forwarded by the merchant, the host cannot initially determine which processor to route the transaction. The host system calculates or acquires the historical cumulative monthly volume for processor A and B such as by accessing volume information stored and updated in the database server. Then the host system selects the processor based on the current monthly volume distribution between processor A and B. Therefore, dynamic routing is more complex than fixed rule processor mappings. The processor can be selected on the fly based on current data/values not part of the received transaction information.
Alternatively, the processor can be selected on the fly based on a prior response from a processor. For example, the transaction may be initially sent to a first processor in order to obtain certain data/values that can affect routing. Once the data/values are received by the host system from the first processor, a determination as to final destination routing is made. If the routing is to a processor other than the first processor, a cancellation request is sent to the first processor and the transaction is rerouted to another processor/financial institution.

### Dynamic Routing Examples

A merchant, Acme, Inc. logs into a configuration interface of the host system to set up routing rules and chooses to have thirty percent of the total volume sent to Processor A and seventy percent of the total volume sent to Processor B (Rule #1). Furthermore, Acme, Inc. adds a rule indicating that all transactions with the CVV (card verification value) response of N (No—this means that the three digit security code on the back of a credit card does not match) should be sent to Processor A (Rule #2). Acme, Inc. saves the rule set and exits the system.

A cardholder, John Smith, places an order for a $50 widget with his credit card. Unbeknownst to John, the transaction is tendered by the merchant and sent through the routing system to Processor A per Rule #1. After the authorization through Processor A, the CVV response was Y (yes) which does not cause a re-routing per Rule#2.

A cardholder, Mary Sue, places an order for the same $50 widget. This time, the transaction is routed to Processor B because there was already $50 sent to Processor A and the routing system attempts to achieve the merchant configured distribution ratio as defined in Rule #1 (30/70). Again the processor (Processor B) returned a CVV response of Y and the transaction is finalized without further routing.

Now John Smith places another order for the $50 widget. The configured distribution rules (in Rule #1) cause the transaction to be routed to Processor B again. John has placed two orders and the ordering experience has not changed at all for him. Without John's knowledge, however, the routing system has sent his transaction to a different processor (Processor B) or Financial Institution per Acme, Inc.'s configuration.

Mary Sue places another order for the $50 widget with her credit card. Rule #1 causes the transaction to be routed to Processor B. This time, however, Processor B returns a CVV response of N. Per Acme's Rule #2, the transaction with Processor B is terminated and the transaction is then routed to Processor A.

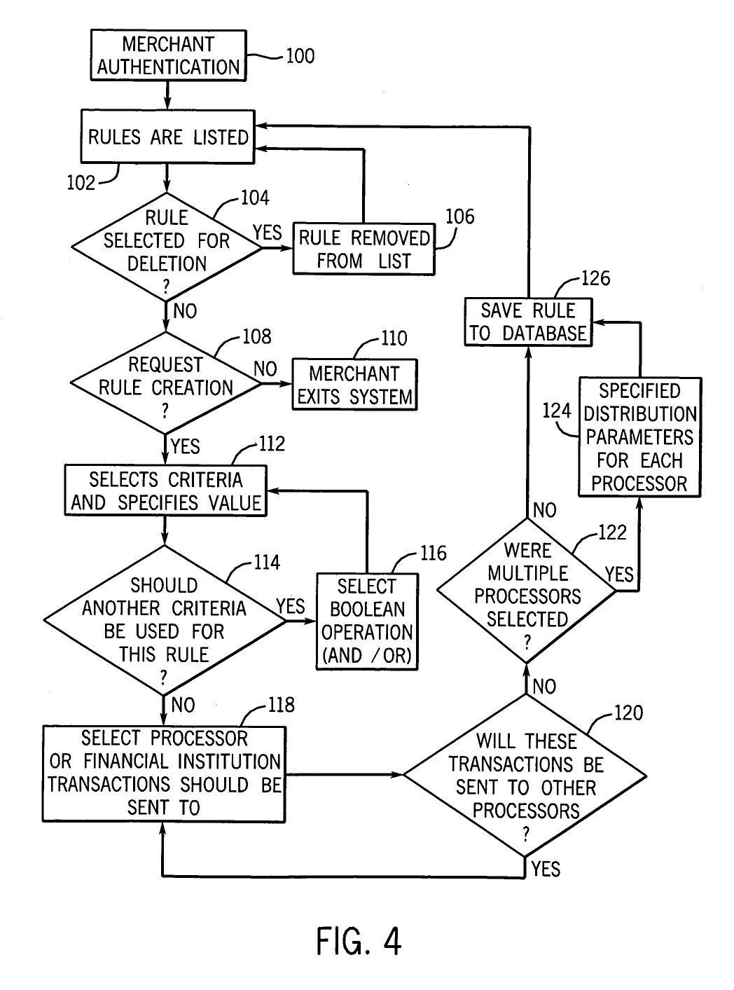

Referring to FIG. 4 an illustrative method is shown by which a merchant or a merchant's agent establishes rules to be utilized for the routing of customer transactions among various processors. The steps may be carried out by the payment gateway/host system 14. In step 100 the merchant or the merchant's agent is authenticated for security purposes on logging in to the interface provided by the host system that controls the creation, modification and storage of the rules. A list of available rules is displayed on the screen of the computer utilized by the merchant to access host 14 as indicated in step 102. Alternatively, the merchant may directly access host 14 at an input terminal connected locally to the host.

A determination is made in step 104 of whether a rule has been selected for deletion. A YES determination results in the selected rule being removed from the list as indicated in step 106 with the process returning to step 102. A NO determination at step 104 results in a determination of whether a rule is to be created in step 108. A NO determination results in the merchant exiting the system as indicated at step 110. A YES determination at step 108 results in the merchant selecting the criteria for a rule and specifying a value associated with the criteria in step 112.

A determination is made in step 114 of whether a further criteria should be used to form the subject rule. A YES determination dates to a selection of an appropriate Boolean operation such as AND or OR in step 116 that will link the previously defined portion of the rule with a new portion of the rule to be selected by the merchant. A NO determination in step 114 means that the new or modified rule has been completed by the merchant and results in the merchant selecting the processor or financial institution to which transactions within the scope of the rule should be sent as indicated at step 118.

In step 120 a determination is made as to whether a transaction within the scope of the rule will be sent to other processors. A YES determination at step 120 return to the process flow to step 118 for the selection of further processors. A NO determination by step 120 results of the determination at step 122 of whether multiple processors were selected. A NO determination by step 122 results in the rule along with the associated processor being stored in the database 26 as indicated at step 126. A YES determination at step 122 results in the selection of distribution parameters to be utilized in determining how transactions are to be distributed among the selected processors at step 124. The distribution criteria as selected by the merchant can be based on one or a plurality of parameters/values such as those described in above examples. The process then continues to step 126. Following step 126 the process returns to step 102 with the merchant exiting the rule interface process by causing NO determinations at steps 104 and 108.

The payment gateway/host system 14 may be implemented by a computer or workstation such as including a microprocessor supported by ROM (read-only memory), RAM (random access memory), nonvolatile data storage such as a hard drive, a communication module supporting the receipt of data from and transmission of data to remote devices, input devices such as a keyboard, mouse, etc. and output devices such as a video display, printer etc. The computer operates under the control of an operating system that provides basic control and functionality among the elements of the computer. One or more application programs in conjunction with the operating system provide stored program control instructions that can be utilized to provide configurable functionality. Those skilled in the art will understand how the functions and operations of the host system described herein can be practiced utilizing such a computer by programming available application programs to implement the described functions and operations.

Although the illustrative embodiment employs a payment gateway to achieve the routing flexibility, other implementations can be utilized. For example, a large merchant such as a department store chain or a high-volume Internet merchant might find it advantageous to incorporate the decision controlling rules as explained herein within a processing node controlled directly by the merchant and/or located at the merchant facilities.

The host 14 in one example employs one or more computer-readable signal-bearing media. The computer-readable signal-bearing media store software, firmware and/or assembly language for performing one or more portions of one or more embodiments of the invention. Examples of a computer-readable signal-bearing medium comprise the recordable database storage medium 26 The computer-readable signal-bearing medium may comprise one or more of a magnetic, electrical, optical, biological, and atomic data storage medium. For example, the computer-readable signal-bearing medium may include floppy disks, magnetic tapes, CD-ROMs, DVD-ROMs, hard disk drives, and electronic memory.

Although exemplary implementations of the invention have been depicted and described in detail herein, it will be apparent to those skilled in the art that various modifications, additions, substitutions, and the like can be made without departing from the spirit of the invention. The scope of the invention is defined in the following claims.

We claim:

1. A transaction routing apparatus comprising:
means for receiving transaction information from a merchant where the transaction information is for a requested purchase by a customer of goods or services of the merchant;
a database adapted to store predetermined rules defined by the merchant where the database also stores at least one identity of at least one transaction processor associated with each predetermined rule, where the transaction processor is a separate transaction processing apparatus;
a rule matching module, coupled to the receiving means and database, that compares the predetermined rules with supplemental information related to transaction routing to determine if any of the rules are satisfied;
a selection module, coupled to the rule matching module, is adapted to transmit the transaction information to the at least one transaction processor with the at least one identity associated with a first rule that is satisfied.

2. The apparatus of claim 1 wherein the rule matching module and the selection module cooperate to make a dynamic routing determination of the at least one transaction processor to which the transaction information will be transmitted.

3. The apparatus of claim 2 further comprising means, coupled to at least one of the rule matching module and selection module, for accessing dynamically updated information, wherein the supplemental information includes the dynamically updated information.

4. The apparatus of claim 3 wherein the dynamically updated information includes a parameter relevant to the transaction containing a cumulative value that is updated on a per transaction basis.

5. The apparatus of claim 4 wherein the parameter comprises one of: quantity of transactions transmitted to a particular transaction processor, and dollar volume of transactions transmitted to a particular transaction processor.

6. The apparatus of claim 2 further comprising means coupled to the database for updating and storing dynamically updated information on a per transaction basis, where the dynamically updated information is part of the supplemental information.

7. A method implemented by a transaction routing apparatus for routing transaction information comprising the steps of:
receiving transaction information from a merchant where the transaction information is for a requested purchase by a customer of goods or services of the merchant;
storing predetermined rules defined by the merchant where the database also stores at least one identity of at least one transaction processor associated with each predetermined rule, where the transaction processor is a separate transaction processing apparatus;
comparing the predetermined rules with supplemental information related to transaction routing to determine if any of the rules are satisfied;
determining one of the at least one transaction processors to receive the transaction information based on the at least one identity associated with a first rule that is satisfied;
transmitting the transaction information to the one of the at least one transaction processors.

8. The method of claim 7 wherein the determining step makes a dynamic routing determination of the at least one transaction processor to which the transaction information will be transmitted.

9. The method of claim 8 further comprising accessing dynamically updated information, wherein the supplemental information includes the dynamically updated information.

10. The method of claim 9 wherein the dynamically updated information includes a parameter relevant to the transaction containing a cumulative value that is updated on a per transaction basis.

11. The method of claim 10 wherein the parameter comprises one of: quantity of transactions transmitted to a particular transaction processor, and dollar volume of transactions transmitted to a particular transaction processor.

12. The method of claim 8 further comprising updating and storing dynamically updated information on a per transaction basis, where the dynamically updated information is part of the supplemental information.

13. An article, comprising:
one or more computer-readable signal-bearing media;
means in the one or more media for receiving transaction information from a merchant where the transaction information is for a requested purchase by a customer of goods or services of the merchant;
means in the one or more media for storing predetermined rules defined by the merchant where the database also stores at least one identity of at least one transaction processor associated with each predetermined rule, where the transaction processor is a separate transaction processing apparatus;
means in the one or more media for comparing the predetermined rules with supplemental information related to transaction routing to determine if any of the rules are satisfied;
means in the one or more media for determining one of the at least one transaction processors to receive the transaction information based on the at least one identity associated with a first rule that is satisfied; and
means in the one or more media for transmitting the transaction information to the one of the at least one transaction processors.

14. The article of claim 13 further comprising means in the one or more media for making a dynamic routing determination of the at least one transaction processor to which the transaction information will be transmitted.

15. The article of claim 14 further comprising means in the one or more media for accessing dynamically updated information, wherein the supplemental information includes the dynamically updated information.

16. The article of claim 15 wherein the dynamically updated information includes a parameter relevant to the transaction containing a cumulative value that is updated on a per transaction basis.

17. The article of claim 16 wherein the parameter comprises one of: quantity of transactions transmitted to a particular transaction processor, and dollar volume of transactions transmitted to a particular transaction processor.

18. The article of claim 14 further comprising means in the one or more media for updating and storing dynamically updated information on a per transaction basis, where the dynamically updated information is part of the supplemental information.
